(19) United States
(12) Patent Application Publication
(10) Pub. No.: US 2010/0251100 A1
(43) Pub. Date: Sep. 30, 2010

(54) PRIMITIVE-BASED PRESENTATION OF DIMENSIONAL INFORMATION USING LAYOUT SCRIPT

(76) Inventor: Yann Delacourt, Maisons-Laffitte (FR)

Correspondence Address: SAP AG c/o BUCKLEY, MASCHOFF & TALWALKAR LLC, 50 LOCUST AVENUE, NEW CANAAN, CT, 06840, US

(21) Appl. No.: 12/415,189

(22) Filed: Mar. 31, 2009

(51) Int. Cl. G06F 17/00; G06F 17/30

(52) U.S. Cl. 715/240; 715/243; 707/E17.044

(57) ABSTRACT

Some aspects include determination of a report structure defining a frame, the frame associated with a graphical primitive and a data axis, obtaining data associated with the data axis from a structured data source, creation of one or more instances of the graphical primitive based on the data associated with the data axis and on an axis expression of a layout script, determination of one or more graphical properties associated with each of the one or more instances of the graphical primitive based on the data associated with the data axis and on a property expression of the layout script, and outputting a report including the one or more instances of the graphical primitive and the one or more graphical properties associated therewith.

### BACKGROUND

Enterprise software systems receive, generate and store data related to many aspects of a business enterprise. In some implementations, this enterprise data may relate to marketing, sales, customer relations, supplier relations, inventory, human resources, and/or finances. Graphical reporting systems are commonly used to present enterprise data to users in a coherent manner.

Conventional graphical reporting systems create graphical reports based on report specifications. A report specification defines the layout of report elements (e.g., sections, tables, columns, rows, header, footer, etc.), and the data which is to populate the report elements. When a report is requested, a reporting system generates the report based on a corresponding report specification and stored enterprise data. If the data changes, a report which is subsequently generated based on the same report specification will include the changed data.

FIG. 1 is a block diagram of an architecture of conventional reporting system 100. Structured data 110 may comprise a repository storing data objects (e.g., dimensions, measures, details) as well as the aforementioned report specifications. To create a report based on a stored report specification, calculation engine 120 first extracts appropriate data from structured data 110, performs any calculations required by the report specification, and represents the resultant data according to an internal data model.

Layout components 130 translate the data from the internal model to one or more layout models according to the report specification. Each of layout components 130 corresponds to a particular visualization type (e.g., chart, table, etc.). For example, the layout of a chart in a report may be delegated to one of layout components 130 which is dedicated to chart layout (e.g., a chart engine). This dedicated layout component utilizes its own model for data representation (e.g., data series). Accordingly, the internal model is converted to the model utilized by the layout component dedicated to chart layout.

Rendering engine 140 may include libraries or procedures dedicated to rendering specific visualization types. These libraries are exposed to layout components 130 via respective ones of APIs 145. Continuing with the above example, the layout component 130 dedicated to charting calls one of APIs 145 which corresponds to the chart-rendering libraries of rendering engine 140.

Output client 150 includes controllers 155. Each of controllers 155 is dedicated to outputting a specific visualization type. Output client 150 may include a controller 155 for outputting a chart as received from the chart-rendering libraries of rendering engine 140.

Architecture 100 presents extensibility issues. In order to add support for a new visualization type, architecture 100 requires a new layout component, a new rendering method, and a new client controller. Similarly, in order to change (e.g., enrich) an existing visualization type, corresponding ones of these elements must be rewritten, tested and deployed.

Each visualization type (and corresponding components) is independent of each other and interactions therebetween are not explicitly supported. Consequently, composition of different visualization types is impractical.

### BRIEF DESCRIPTION OF THE DRAWINGS

FIG. 1 is a block diagram of a conventional architecture.

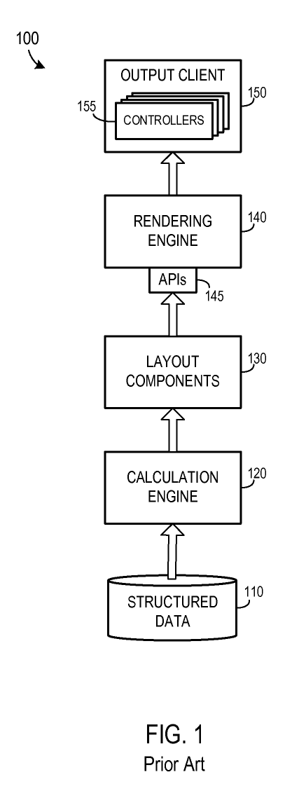

FIG. 2 is a block diagram of an architecture according to some embodiments.

FIG. 3 is a conceptual diagram of logical relationships according to some embodiments.

FIG. 4 is a flow diagram of a process according to some embodiments.

FIG. 5 illustrates a report structure, a layout script and a corresponding report output according to some embodiments.

FIG. 6 illustrates a report structure, a layout script and a corresponding report output according to some embodiments.

FIG. 7 illustrates a report structure, a layout script and a corresponding report output according to some embodiments.

FIG. 8 illustrates a report structure, a layout script and a corresponding report output according to some embodiments.

FIG. 9 illustrates a report structure, a layout script and a corresponding report output according to some embodiments.

FIG. 10 illustrates a report structure, a layout script and a corresponding report output according to some embodiments.

FIG. 11 illustrates a report structure, a layout script and a corresponding report output according to some embodiments.

FIG. 12 illustrates a report structure, a layout script and a corresponding report output according to some embodiments.

FIG. 13 illustrates a report structure, a layout script and a corresponding report output according to some embodiments.

FIG. 14 illustrates a report structure, a layout script and a corresponding report output according to some embodiments.

### DETAILED DESCRIPTION

The following description is provided to enable any person in the art to make and use the described embodiments and sets forth the best mode contemplated for doing so. Various modifications will remain readily apparent to those in the art.

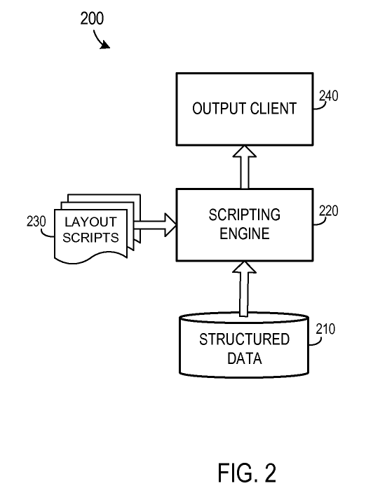

FIG. 2 is a block diagram illustrating system 200 according to some embodiments. Each element of system 200 may comprise any suitable combination of hardware and/or software, and each element may be located remote from one or more other elements. System 200 may operate to generate a report according to some embodiments. Embodiments are not limited to system 200.

Structured data 210 may comprise any data source which supports entities and relations therebetween. Structured data 210 may comprise one or more relational, OLAP, XML, and/or tabular data sources.

Structured data 210 may comprise a semantic layer including a set of abstract entities known as semantic objects, each of which associates one or more physical entities of one or more data sources (not shown) with user-friendly names. The semantic objects may exhibit properties (i.e., metadata), such as a data type (e.g., text or numeric), a “qualification” (e.g., dimension, measure, detail . . . ), a “business type” (e.g., financial, time, geography, KPI . . . ), and a structure (e.g., OLAP hierarchies). Types of semantic layers and semantic objects are described in U.S. Pat. No. 5,555,403, and are provided by Business Objects products or other Business Intelligence products. Examples of semantic layers according to some embodiments include Business Objects Universes and OLAP data models.

Structured data 210 may also include report structures according to some embodiments. As will be described in further detail below, a report structure consists of a frame associated with a graphical primitive and at least one data axis. The frame may include zero or more other frames, each of which is also associated with a graphical primitive and at least one data axis. Any frames may be nested within any other frame.

Scripting engine 220 may generate a report based on a report structure and data of structured data 210, and on one of layout scripts 230. Generally, each of layout scripts 230 describes how primitive shapes are arranged with respect to one another within a report. Each of layout scripts 230 includes at least one axis expression and at least one property expression. As will be described below, scripting engine 220 may create instances of a graphical primitive associated with a frame based on data associated with a data axis of the frame and on an associated axis expression of a layout script. Similarly, scripting engine 220 may determine graphical properties of the graphical primitive instances based on data associated with the data axis of the frame and on an associated property expression of the layout script. Structured data 210 may store layout scripts 230 according to some embodiments.

Scripting engine 220 generates a report output including one or more of graphical primitives (e.g., line, box, curve, polygon, circle, etc.) with specified graphical properties (e.g., x-pos, y-pos, z-pos, size, depth, color, focal point, orientation, vertices, center, etc.), and transmits the report output to output client 240. Output client 240 may therefore require only basic graphical rendering functionality to display a report based on the report output.

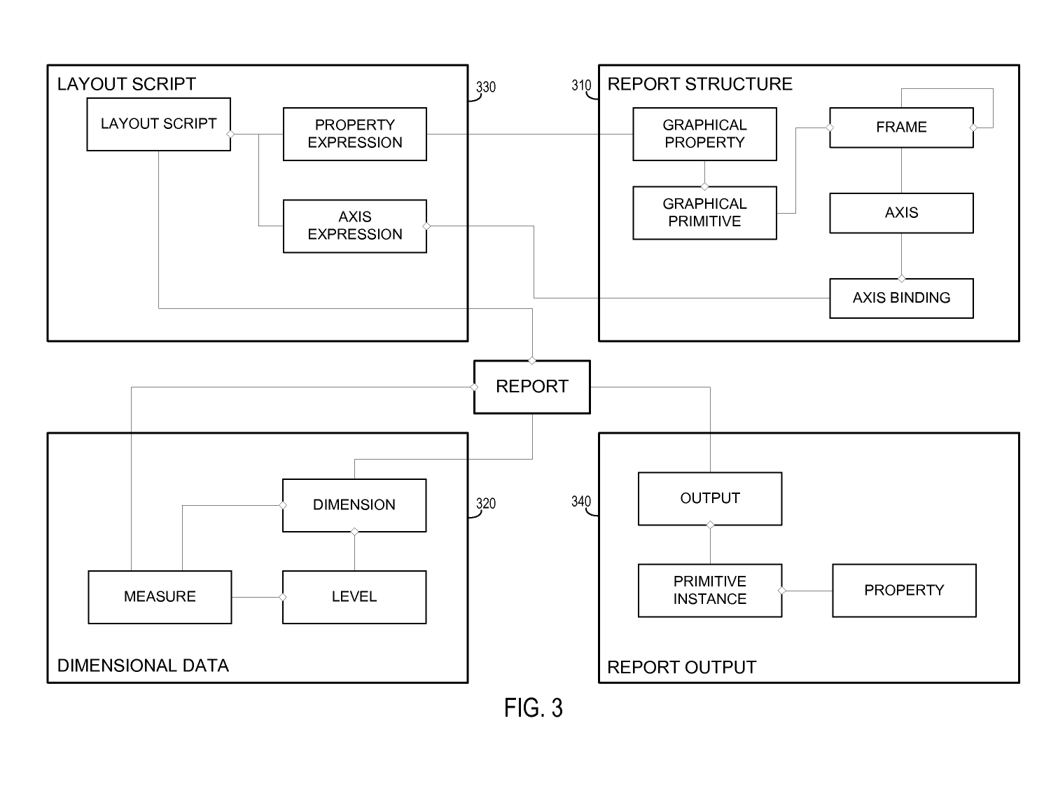

FIG. 3 is a conceptual diagram of logical relationships between the aforementioned entities according to some embodiments. A frame (shown in report structure 310) represents a single type of graphical primitive which is linked to dimensional data 320 (e.g. semantic objects, OLAP objects, etc.). A frame may also be linked to other types of data (e.g., RecordSet fields) in some embodiments. As shown, a frame of report structure 310 may be a parent to one or more other frames.

The link to dimensional data is provided via one or more data axes associated with each frame. Each of the data axes drives the generation of instances of a frame. More particularly, the number of frame instances which will be generated is determined by the actual values of the data axes. The position and other graphical properties of each individual frame instance are determined by layout script 330 as will be described below.

Instantiation of a child frame instance is driven by the data axes of its parent frame. According to some embodiments, a child frame inherits the axes of its parent frame and instantiations thereof iterate over the same axes space. A child frame may be associated with all or part of the axes associated with its parent frame.

The graphical primitive associated with a particular frame may itself be associated with one or more graphical properties. The specific graphical properties for a particular instance of the graphical primitive are determined based on a corresponding property expression of a corresponding layout script 330. By virtue of these property expressions, layout script 330 may control the location (i.e., layout) of a graphical primitive instance with respect to each other graphical primitive instance of report output 340. A property expression may be based on values of dimensional data 320, properties of other (e.g., adjacent) primitive instances, etc. For example, a size of a graphical primitive instance may be based on a magnitude of the data associated with the primitive instance and/or an upper y-position of the primitive instance may be based on a lower y-position of a previous primitive instance.

Layout script 330 also includes axis expressions to drive the generation of primitive instances. The axis expressions (and therefore the generation of primitive instances) may depend at least in part upon the data model expressed within dimensional data 320. In this regard, an axis expression and a property expression of a layout script may be parameterized to allow use with other report structures and/or data bindings.

Layout script 330 may comprise a set of declarative statements governed by grammatical rules. The following describes the grammar of layout script 330 according to some embodiments.

```
layout_{—} script :
    ( assign_exp )+
assign_exp
    prop_current_member_exp ASSIGN
    ( exp | bool_exp )
    SEMI
    ;
exp :
    priorityl_exp
    ( ( PLUS | MINUS ) priorityl exp )*
    ;
priorityl exp :
    leafexp
    ( ( MULTIPLY | DIVIDEBY | MOD ) leafexp )*
    ;
leafexp :
    constant
    | prop_member_exp
    | summ_function
    | function
    | LPARENS exp RPARENS
    ;
prop_member_exp :
    member_exp
    ( DOT NAMETOKEN )?
    ;
member_{—} exp :
    identity_{—} exp
    ( DOT ( PREVIOUS _ NEXT _ CHILDREN _ PARENT _{—}
    ANCESTOR _ SIBLING ) )*
    ;
prop_current_member_exp :
    identity_exp
    ( DOT NAMETOKEN )?
    ;
bool_exp :
    leaf exp
    ( ( NEQ | EQ | LT | GT | LTE | GTE ) leafexp )?
    ;
leafbool_exp :
    OR LPARENS bool exp COMMA bool_exp RPARENS
    | AND LPARENS bool_exp COMMA bool exp RPARENS
    | NOT LPARENS bool_exp RPAREN
    | LPARENS bool exp RPARENS
    |
    ( TRUE | FALSE )
    ;
identity_exp :
    LBRAQ NAMETOKEN RBRAQ
    ;
constant
    STRING
    | NUMBER
    | NULL
    ;
summ_function :
    ( SUM | COUNT | MIN | MAX | AVERAGE )
    LPARENS exp
    ( COMMA axis exp )?
    RPARENS
    ;
function :
    IF LPARENS bool_exp COMMA exp COMMA exp RPARENS
    | SIN LPARENS exp RPARENS
    | COS LPARENS exp RPARENS
    | TAN LPARENS exp RPARENS
    ;
axis_{—} function :
    SETUNION LPARENS axis_exp COMMA axis_{—} exp RPARENS
    | SETINTERSECTION LPARENS axis _exp COMMA axis _exp
    RPARENS
    | SETMINUS LPARENS axis_{—} exp COMMA
    axis_{—} exp RPARENS
    | LPARENS axis_function RPARENS
    :
axis_exp :
    LPARENS
    ( axis_function | identity_exp )
    ( COMMA (axis function | identity exp ) )*
    RPARENS
    | axis_{—} function
    | identity_exp
    :
```

As will be evident from the examples below, the formula-related grammar above may be useful for positioning child frames or frames associated with different sets of axes. For example, functions such as Min, Max, Sum, Count, etc. could be performed not only on data but on graphical properties as well. Since such usage requires the functions to be evaluated in an axis context, the IN function allows specification of the context in which any expression is to be evaluated.

By virtue of the foregoing, report output 340 consists merely of a collection of primitive instances, each of which is associated with one or more properties. Report output 340 may therefore be rendered by any graphical software having knowledge of the primitives and properties. Dedicated report rendering applications are therefore not required according to some embodiments.

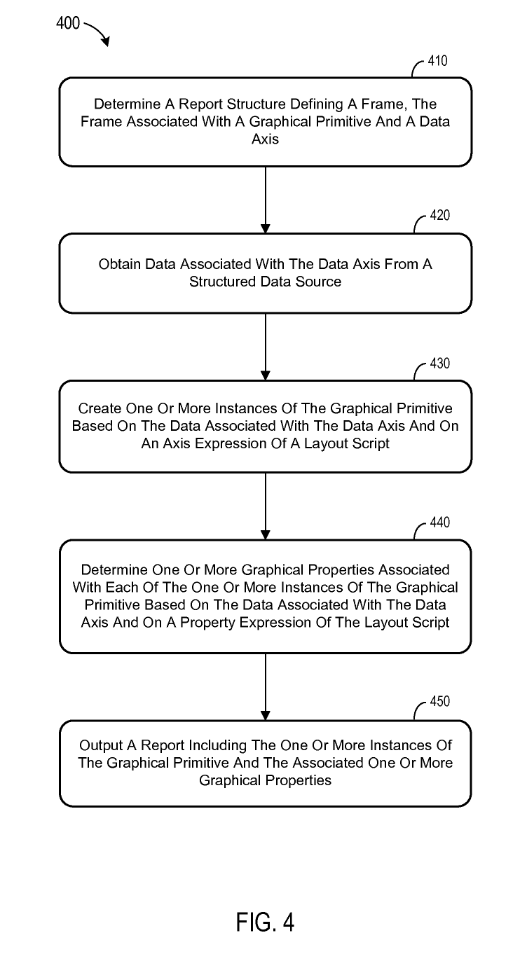

FIG. 4 is a flow diagram of process 400 according to some embodiments. Process 400 may be executed by computer hardware and/or embodied in program code stored on a tangible medium, but embodiments are not limited thereto. Process 400 is embodied by scripting engine 220 in some embodiments.

Initially, a report structure is determined at 410. The report structure defines a frame, and the frame is associated with a graphical primitive and a data axis. As described above, the frame may be associated with more than one data axis. The report structure may be stored among structured data 210 and acquired therefrom by scripting engine 220 in response to a request from output client 240.

Next, at 420, data associated with the data axis is obtained from a structured data source. The data may include values of the data axis (e.g., Years) as well as data related to the data axis (e.g., Sales). Also obtained at 420 may be data associated with other data axes of the frame and data associated with the data axes of other frames of the report structure.

One or more instances of the graphical primitive are created at 430. The one or more instances of the graphical primitive are created based on the data associated with the data axis and on an axis expression of the layout script. In one simple example, one instance of the primitive is created for every value of the data axis. For frames associated with more than one axis, the axis expression will specify how many instances to create based on values of the more than one associated axis. Scripting engine 220 may also provide default behavior for creating primitive instances based on associated axes.

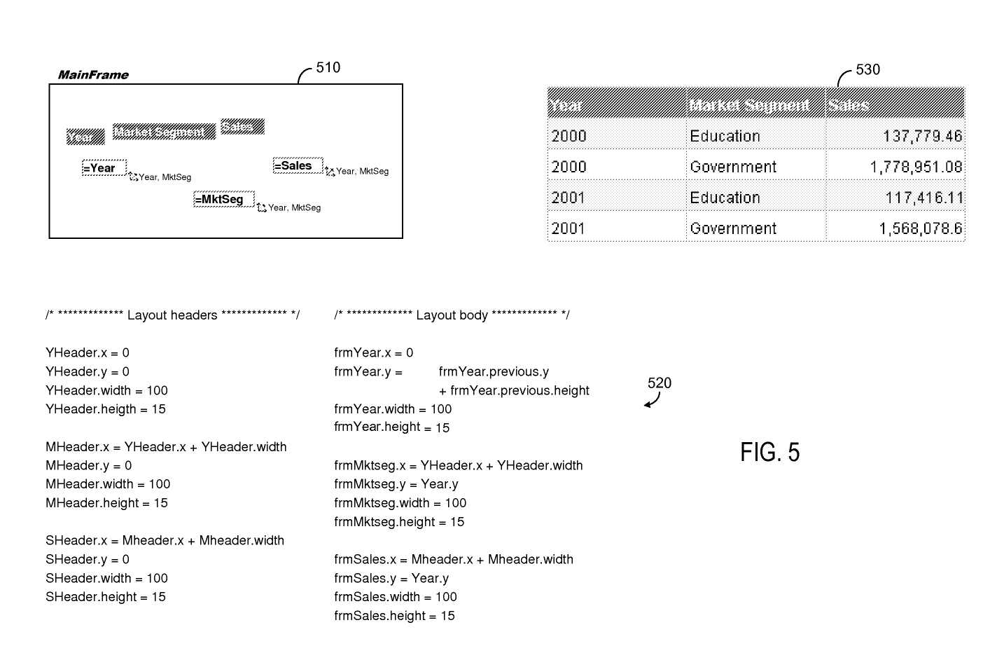

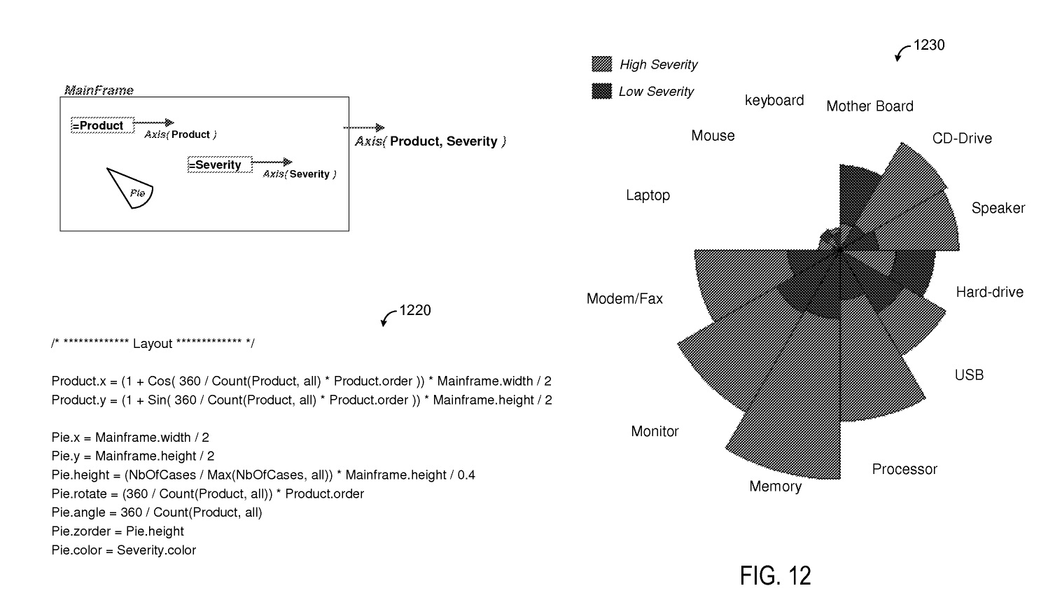

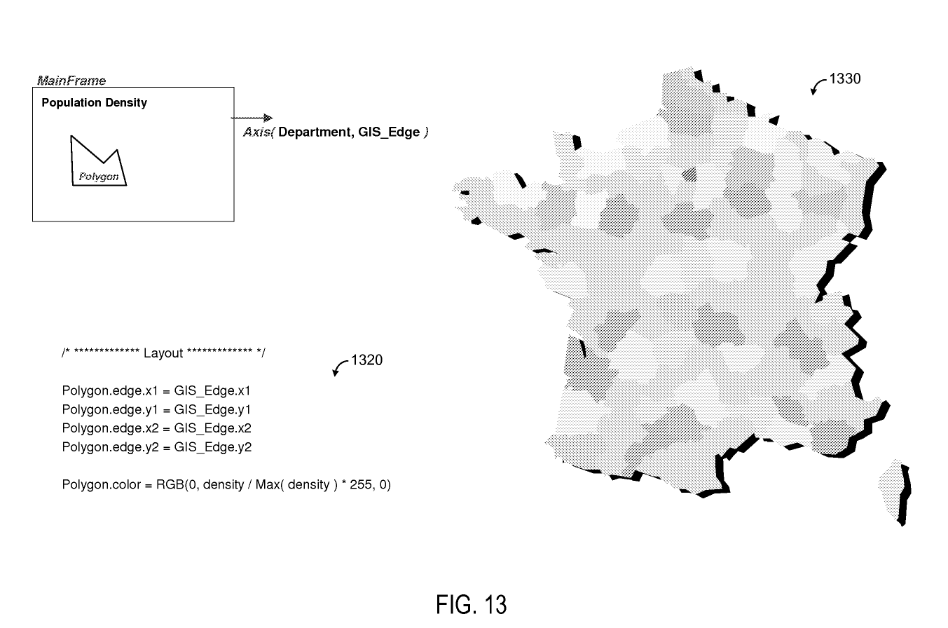

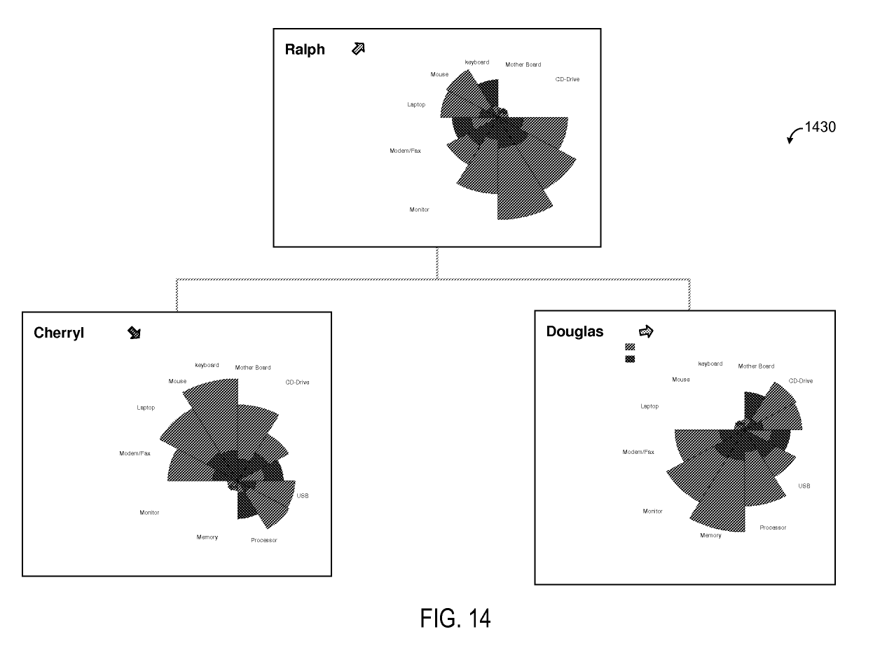

One or more graphical properties are then determined at 440 based on the data associated with the data axis and on a property expression of the layout script. The determined one or more graphical properties are associated with each of the one or more instances of the graphical primitive created at 430. Accordingly, the position, color, size, rotation, etc. of each graphical instance may differ based on the property expression and the data associated with the data axis. Examples of the foregoing are set forth in FIGS. 5 through 14.

Lastly, at 450, a report is output including the one or more instances of the graphical primitive and the associated one or more graphical properties. An output client may use this information (primitive instances and associated properties) to render a graphical report.

Some embodiments may therefore achieve any type of report layout through declaration of an expression that computes a position of primitive instances (x-pos, y-pos, z-pos, width, height, depth, rotation, etc.) and their graphical properties (color, border, shading, etc.). In contrast to those systems described in the Background, the layout is not dependent upon the availability and capabilities of several visualization-specific components.

More specifically, according to some embodiments, a pie chart is not an API that exposes the elements of a pie chart (e.g., a series of data) but is represented as a set of pie primitives laid out around a point according to a layout script. The rendering of the pie chart can be changed dramatically by simply changing the layout script, as opposed to changing the pie chart API by rewriting its library's code. Since visualization is achieved using a layout script and a frame, and frames can be combined, the types of available visualizations may be infinitely composable and extendable.

Moreover, embodiments may directly leverage the structure of the data model by basing the primitive instances and their layout on data axes. Actions performed on the data model (e.g., slice, pivot of axes) may seamlessly alter the report layout. Conversely, actions performed on the report layout may be seamlessly translated into the data model. For example, a selection of an axis thru a graphical representation may be simply interpreted as selection of an axis regardless of the type of the graphical representation (e.g., a set of pies, a set of bars, a set of columns, a set of sections, etc.).

As mentioned above, a layout script may use parameters to represent axes. Such a layout script is not tied to a specific set of axes. Accordingly, the layout script may be used as a template. Further, according to some embodiments, frames associated with a layout script may be combined infinitely by combining their associated data axes, and a corresponding report layout can be generated based on the combined data axes. Such axes combination involves well-known operations such as Cross-Join and Projection.

FIGS. 5 through 14 each illustrate a report structure, a layout script and a corresponding report output according to some embodiments. FIGS. 5 through 14 are intended to demonstrate some of the myriad of possibilities provided by some embodiments, but such possibilities are not limited to those demonstrated.

FIG. 5 illustrates generation of a table visualization according to some embodiments. Report structure 510 includes frames associated with the axes Year and MktSeg. Layout script 520 includes axis expressions and property expressions associated with these axes. Report structure 510, layout script 520 and structured data associated with these axes may be processed according to process 400 to result in rendered report output 530.

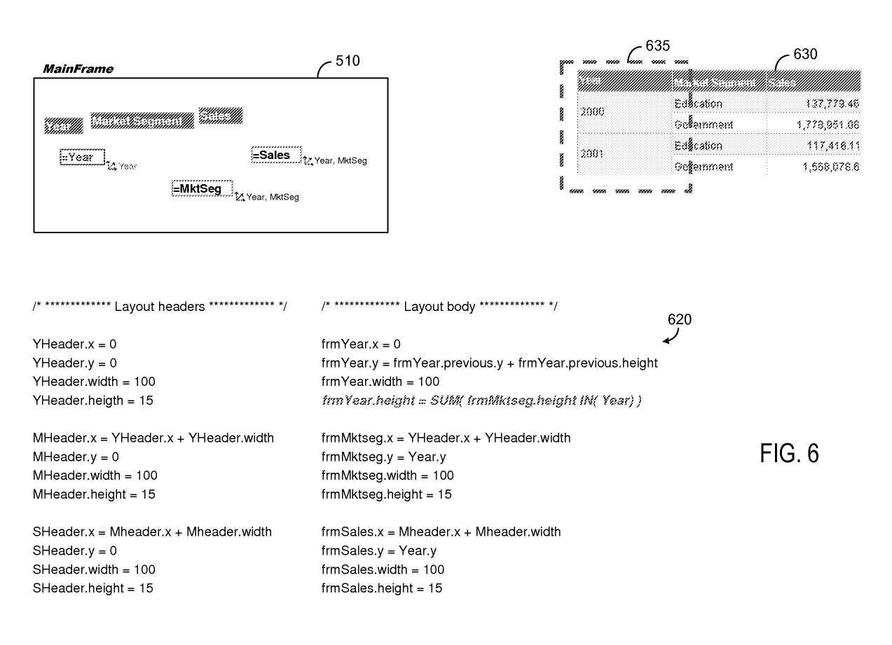

FIG. 6 provides an example of how changes to a layout script may affect a report output, even though the report structure remains unchanged. Accordingly, FIG. 6 shows report structure 510 from FIG. 5 and changed layout script 620. In particular, the declaration “frmYear.height=15” of layout script 520 has been changed to the declaration “frmYear.height=SUM(frmMktseg.height IN(YEAR))”. As a result, column 635 of report output 630 has changed from four rows of a particular height to two rows exhibiting double the particular height.

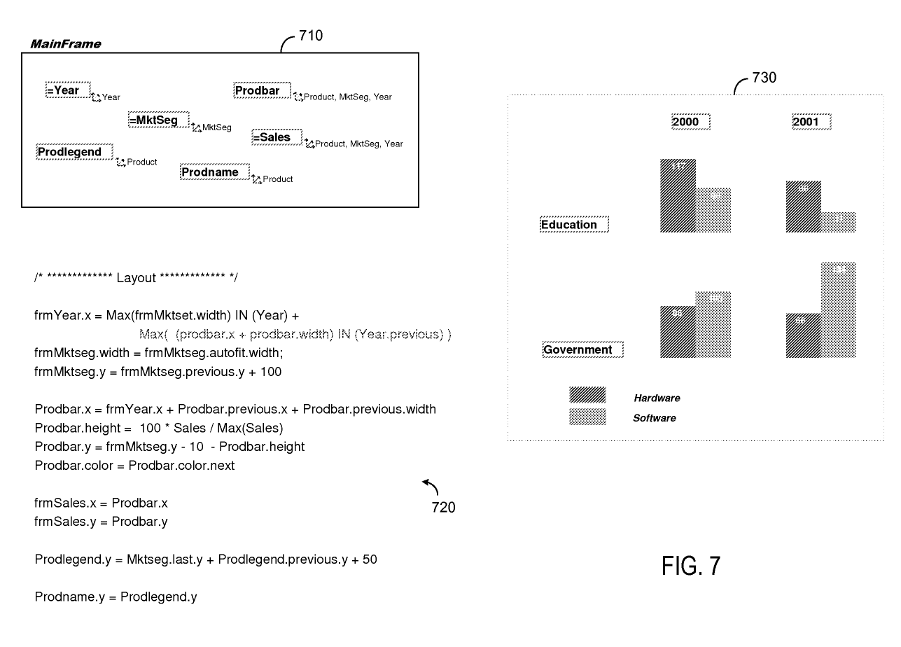

Report structure 710 of FIG. 7 is significantly more complex than report structure 510. Some frames of report structure 710 are associated with one axis and others with three axes. Layout script 720 operates in conjunction with report structure 710 (and with structured data of the axes thereof) to generate report output 730. Report output 730 includes bar chart visualizations, in which a size property of the Sales frame instances depends upon data values associated with the Sales axis.

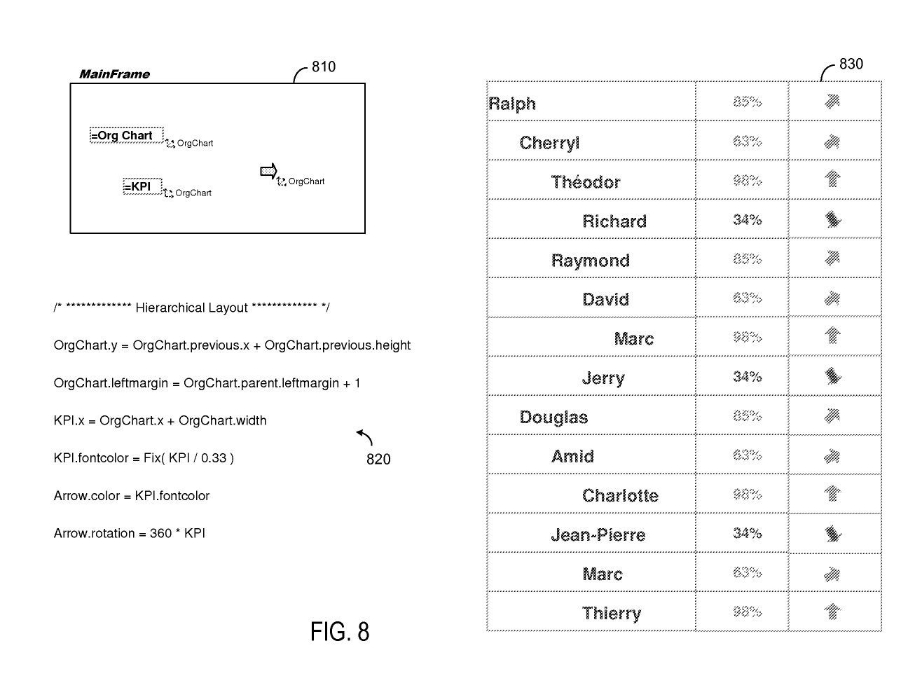

FIG. 8 illustrates a hierarchical layout according to some embodiments. Report structure 810 includes two frames associated with box graphical primitives as in the preceding examples, and a third frame associated with an arrow graphical primitive. As shown in layout script 820, the color and rotation properties of each arrow primitive instance are determined based on organizational chart data. Report output 830 presents these graphical properties as determined for a particular set of organizational chart data.

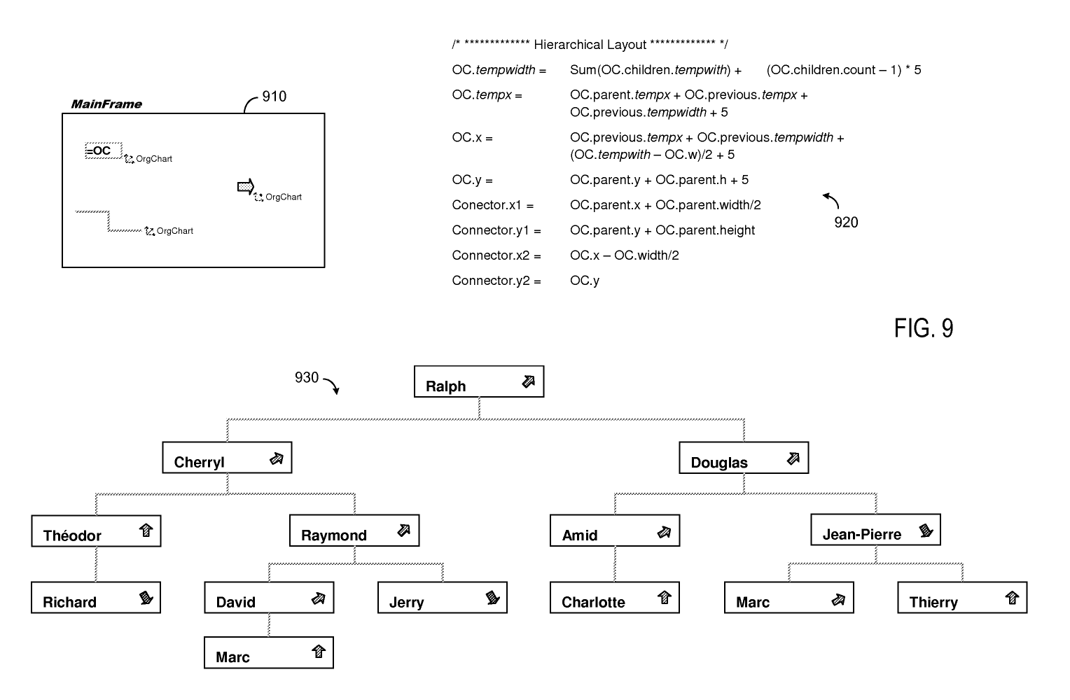

FIG. 9 shows another form of hierarchical layout using the same hierarchy as visualized in FIG. 8. Report structure 910 includes frames associated with box and arrow primitives as described above, as well as a frame associated with a line primitive. Layout script 920 includes property expressions and axis expressions for determining instances and associated properties of each of these frames. The instances are presented according to layout script 920 (and associated structured data) in report output 930. Report output 930 includes thirteen instances of the frame associated with the line primitive and fourteen instances each of the frames associated with the box and arrow primitives.

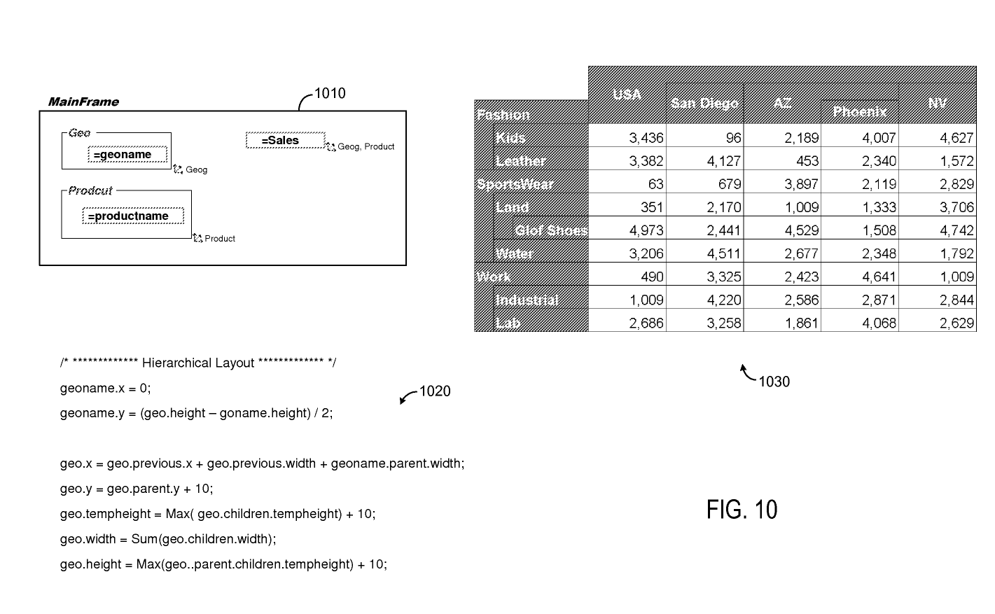

FIG. 10 illustrates generation of a cross-tab visualization according to some embodiments. As shown, report structure 1010 includes two sets of parent-child frames (i.e., ignoring the main frame as a parent frame to its included frames). Once the frame relationships and associated axes are defined as shown in report structure 1010, layout script 1020 for generating report output 1030 is strikingly straightforward. Again, small changes to report structure 1010 and to layout script 1020 may result in significant changes to report output 1030. Moreover, the axes may be parameterized to allow cross-tab visualization of other data axes.

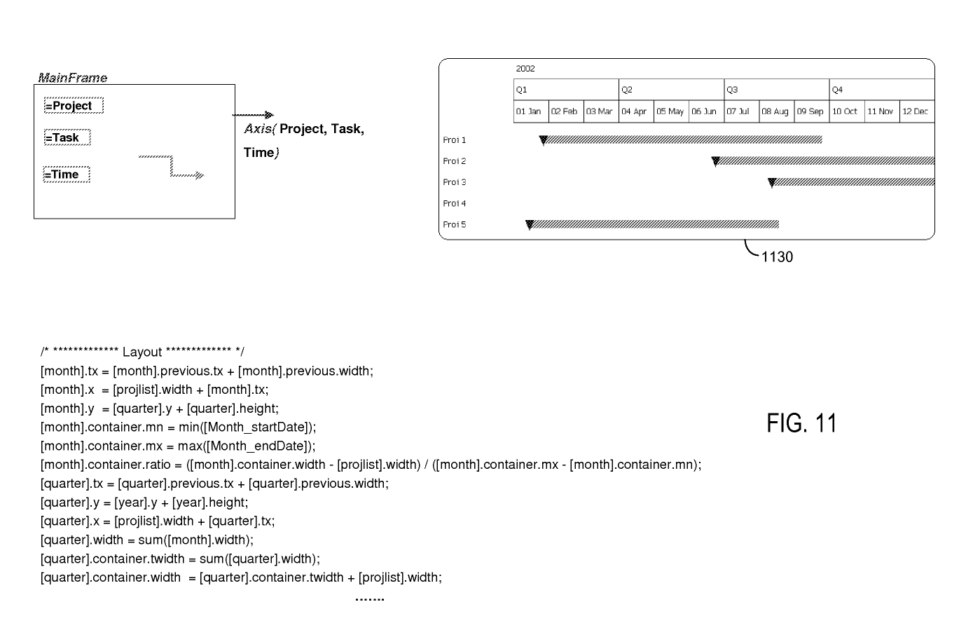

FIGS. 11 through 13 respectively illustrate generation of GANTT chart 1130, weighted stacked pie chart 1230 and density map 1330 according to some embodiments. The simplicity of layout scripts 1220 and 1320 demonstrate the powerful capabilities provided by some embodiments. In this regard, visualization templates may be composed in some embodiments to result in new visualizations. In a particular example based on FIGS. 9 and 12, FIG. 14 illustrates report output 1430 including a weighted stacked pie chart nested into an organizational chart.

According to some embodiments, the layout script grammar provides a declarative way of defining feedback on a rendered report output. Examples of such feedback include displaying a number in response to placing a cursor over a displayed primitive instance, and/or displaying a vertical line as a cursor follows a displayed curve.

Layout script grammar according to some embodiments may provide events for handling by an attached controller, such as a controller within output client 240. This event handling may allow a user to perform actions such as adding a column into a block or adding a curve into a graph.

Other events may be generated and handled internally based on the layout script. The events may be handled by controllers bound to a frame so as to receive messages when an action is performed on the frame. A controller may comprise an infoobject and a function coded in a compiled language. For example, a frame instance may include a boolean property “visible” which determines whether the frame instance is visible. A controller may change this property (and the resulting rendered report output) if a corresponding parent frame instance is double-clicked. In another example, a user may control an input widget such as a slider, and an associated controller may incrementally change a property of an associated frame instance in the rendered report output.

The embodiments described herein are solely for the purpose of illustration. Those in the art will recognize that other embodiments may be practiced with modifications and alterations limited only by the claims.

What is claimed is:

1. A method comprising:
determining a report structure defining a frame, the frame associated with a graphical primitive and a data axis;
obtaining data associated with the data axis from a structured data source;
creating one or more instances of the graphical primitive based on the data associated with the data axis and on an axis expression of a layout script;
determining one or more graphical properties associated with each of the one or more instances of the graphical primitive based on the data associated with the data axis and on a property expression of the layout script; and
outputting a report including the one or more instances of the graphical primitive and the one or more graphical properties associated therewith.

2. A method according to claim 1,
wherein creating the one or more instances of the graphical primitive comprises creating only one instance of the graphical primitive for each distinct data value associated with the data axis.

3. A method according to claim 1, wherein the report structure defines a second frame, the second frame associated with a second graphical primitive, the data axis, and a second data axis, the method further comprising:
obtaining second data associated with the data axis and the second data axis from the structured data source;
creating one or more instances of the second graphical primitive based on the second data and on a second axis expression of the layout script; and
determining one or more graphical properties associated with each of the one or more instances of the second graphical primitive based on the second data associated with the data axis and the second data axis and on a second property expression of the layout script,
wherein the report includes the one or more instances of the second graphical primitive and the one or more graphical properties associated therewith.

4. A method according to claim 3, wherein the graphical primitive and the second graphical primitive are identical.

5. A method according to claim 3,
wherein creating the one or more instances of the graphical primitive comprises creating only one instance of the graphical primitive for each distinct data value associated with the data axis.

6. A method according to claim 3, wherein the report structure defines a third frame, the third frame associated with a third graphical primitive and the second data axis, the method further comprising:
obtaining third data associated with the second data axis from the structured data source;
creating one or more instances of the third graphical primitive based on the third data and on a third axis expression of the layout script; and
determining one or more graphical properties associated with each of the one or more instances of the third graphical primitive based on the third data associated with the second data axis and on a third property expression of the layout script,
wherein the report includes the one or more instances of the third graphical primitive and the one or more graphical properties associated therewith.

7. A method according to claim 3, wherein the report structure defines a third frame, the third frame associated with a third graphical primitive, the data axis, and the second data axis, the method further comprising:
obtaining third data associated with the data axis and the second data axis from the structured data source;
creating one or more instances of the third graphical primitive based on the third data and on a third axis expression of the layout script; and
determining one or more graphical properties associated with each of the one or more instances of the third graphical primitive based on the third data associated with the data axis and the second data axis and on a second property expression of the layout script,
wherein the report includes the one or more instances of the third graphical primitive and the one or more graphical properties associated therewith.

8. A method according to claim 1, wherein the axis expression of the layout script is parameterized.

9. A method according to claim 8, wherein the layout script comprises declarative statements.

10. A system comprising:
a database storing structured data; and
a scripting engine to:
determine a report structure defining a frame, the frame associated with a graphical primitive and a data axis;
obtain data associated with the data axis from the database;
create one or more instances of the graphical primitive based on the data associated with the data axis and on an axis expression of a layout script;
determine one or more graphical properties associated with each of the one or more instances of the graphical primitive based on the data associated with the data axis and on a property expression of the layout script; and
output a report including the one or more instances of the graphical primitive and the one or more graphical properties associated therewith.

11. A system according to claim 10,
wherein creation of the one or more instances of the graphical primitive comprises creation of only one instance of the graphical primitive for each distinct data value associated with the data axis.

12. A system according to claim 10, wherein the report structure defines a second frame, the second frame associated with a second graphical primitive, the data axis, and a second data axis, the scripting engine further to:
obtain second data associated with the data axis and the second data axis from the structured data source;
create one or more instances of the second graphical primitive based on the second data and on a second axis expression of the layout script; and
determine one or more graphical properties associated with each of the one or more instances of the second graphical primitive based on the second data associated with the data axis and the second data axis and on a second property expression of the layout script,
wherein the report includes the one or more instances of the second graphical primitive and the one or more graphical properties associated therewith.

13. A system according to claim 12, wherein the graphical primitive and the second graphical primitive are identical.

14. A system according to claim 12,
wherein creation of the one or more instances of the graphical primitive comprises creation of only one instance of the graphical primitive for each distinct data value associated with the data axis.

15. A system according to claim 12, wherein the report structure defines a third frame, the third frame associated with a third graphical primitive and the second data axis, the scripting engine further to:
obtain third data associated with the second data axis from the structured data source;
create one or more instances of the third graphical primitive based on the third data and on a third axis expression of the layout script; and
determine one or more graphical properties associated with each of the one or more instances of the third graphical primitive based on the third data associated with the second data axis and on a third property expression of the layout script,
wherein the report includes the one or more instances of the third graphical primitive and the one or more graphical properties associated therewith.

16. A system according to claim 12, wherein the report structure defines a third frame, the third frame associated with a third graphical primitive, the data axis, and the second data axis, the scripting engine further to:
obtain third data associated with the data axis and the second data axis from the structured data source;
create one or more instances of the third graphical primitive based on the third data and on a third axis expression of the layout script; and
determine one or more graphical properties associated with each of the one or more instances of the third graphical primitive based on the third data associated with the data axis and the second data axis and on a second property expression of the layout script,
wherein the report includes the one or more instances of the third graphical primitive and the one or more graphical properties associated therewith.

17. A system according to claim 10, wherein the axis expression of the layout script is parameterized.

18. A system according to claim 17, wherein the layout script comprises declarative statements.

19. A medium storing program code, the program code executable by a computer to:
determine a report structure defining a frame, the frame associated with a graphical primitive and a data axis;
obtain data associated with the data axis from a structured data source;
create one or more instances of the graphical primitive based on the data associated with the data axis and on an axis expression of a layout script;
determine one or more graphical properties associated with each of the one or more instances of the graphical primitive based on the data associated with the data axis and on a property expression of the layout script; and
output a report including the one or more instances of the graphical primitive and the one or more graphical properties associated therewith.

20. A medium according to claim 19,
wherein the program code executable by a computer to create the one or more instances of the graphical primitive comprises:
program code executable by a computer to create only one instance of the graphical primitive for each distinct data value associated with the data axis.

21. A medium according to claim 19, wherein the report structure defines a second frame, the second frame associated with a second graphical primitive, the data axis, and a second data axis, wherein the program code is further executable by a computer to:
obtain second data associated with the data axis and the second data axis from the structured data source;
create one or more instances of the second graphical primitive based on the second data and on a second axis expression of the layout script; and
determine one or more graphical properties associated with each of the one or more instances of the second graphical primitive based on the second data associated with the data axis and the second data axis and on a second property expression of the layout script,
wherein the report includes the one or more instances of the second graphical primitive and the one or more graphical properties associated therewith.

22. A medium according to claim 21, wherein the graphical primitive and the second graphical primitive are identical.

23. A medium according to claim 21,
wherein creating the one or more instances of the graphical primitive comprises creating only one instance of the graphical primitive for each distinct data value associated with the data axis.

24. A medium according to claim 21, wherein the report structure defines a third frame, the third frame associated with a third graphical primitive and the second data axis, wherein the program code is further executable by a computer to:
obtain third data associated with the second data axis from the structured data source;
create one or more instances of the third graphical primitive based on the third data and on a third axis expression of the layout script; and
determine one or more graphical properties associated with each of the one or more instances of the third graphical primitive based on the third data associated with the second data axis and on a third property expression of the layout script,
wherein the report includes the one or more instances of the third graphical primitive and the one or more graphical properties associated therewith.

25. A method according to claim 21, wherein the report structure defines a third frame, the third frame associated with a third graphical primitive, the data axis, and the second data axis, wherein the program code is further executable by a computer to:
obtain third data associated with the data axis and the second data axis from the structured data source;
create one or more instances of the third graphical primitive based on the third data and on a third axis expression of the layout script; and
determine one or more graphical properties associated with each of the one or more instances of the third graphical primitive based on the third data associated with the data axis and the second data axis and on a second property expression of the layout script,
wherein the report includes the one or more instances of the third graphical primitive and the one or more graphical properties associated therewith.
